(19) United States
(12) Patent Application Publication
(10) Pub. No.: US 2021/0070077 A1
(43) Pub. Date: Mar. 11, 2021

(54) LIGHT SOURCES FOR PRINTING DEVICES

(71) Applicant: Hewlett-Packard Development Company, L.P., Spring, TX (US)

(72) Inventor: Kevin Lo, Vancouver, WA (US)

(21) Appl. No.: 16/958,211

(22) PCT Filed: Jan. 25, 2018
(86) PCT No.: PCT/US2018/015301

§ 371 Date: Jun. 26, 2020

(51) Int. Cl. B41J 29/393; B41J 29/46

(52) U.S. Cl. CPC B41J 29/393; B41J 29/46

(57) ABSTRACT

An example printing device may comprise a first sensor to detect when a media pathway is blocked, where the first sensor may send a first signal to a light source to display a first brightness when the media pathway is blocked, and a second sensor to detect when a supply area door is in an open position, where the second sensor is to send a second signal to the light source to display a second brightness when the supply area door is in an open position.

### BACKGROUND

Printing systems, such as printers, copiers, etc., may generate text or images on to print media (e.g., paper, plastic, etc.). Printing systems, generally include a stacking region for the collection of print media. The stacking region may be an output region where a user may receive the print media. In some examples, printing systems may include a finishing device where print media may be collected for a finishing process, such as stapling, three-hole punching, etc. The printing systems may be connected by a media pathway to a finisher that may perform a finishing process on the printable media.

### BRIEF DESCRIPTION OF THE DRAWINGS

FIG. 1 illustrates an example printing device.

FIG. 2 illustrates an example apparatus for a printing device.

FIG. 3 illustrates an example system for a printing device.

FIG. 4 illustrates an example printing device.

FIG. 5 illustrates an example diagram of a medium for a printing device.

### DETAILED DESCRIPTION

Printing devices and systems are described herein. In some examples, a printing device (e.g., inkjet printing device, etc.) may include a first door to cover a media pathway. In some examples, the media pathway may be housed in a first enclosure. In various examples, the first enclosure may include a light source to illuminate a plurality of enclosures. In some examples, the light source may illuminate the media pathway when the media pathway is blocked. For example, if print media is blocking the media pathway the light source may illuminate the media pathway to assist in print media removal.

In some examples, the printing device may include a second enclosure to house a supply area. In various examples, the second enclosure may include a supply area door to cover the supply area. As used herein, a door refers to a hinged, sliding, or revolving barrier at an opening of a printing device or finishing device. In some examples, the first door may obstruct the view of the supply area of the second enclosure. For example, when the supply area door is open the first door may limit the view of the supply area. In some examples, the light source may illuminate the second enclosure when the supply area door is open. For example, when the supply area door is open the light source may illuminate the second enclosure for a clear view of the supply area.

In some examples, the printing device may include a plurality of enclosures to separately house a first sensor and a second sensor. In some examples, a printing device may include a first sensor to detect when the media pathway is blocked and a second sensor to detect when the supply area door is open. For example, the first sensor may be housed in the first enclosure and may send a first signal to the light source when the media pathway is blocked. In some examples, the second sensor may be housed in the second enclosure and may send a second signal to the light source when the supply area door is open.

In some examples, the first sensor and the second sensor may send signals to a light source to display a first brightness and a second brightness. For example, if print media is blocking the media pathway the first sensor may send a first signal to the light source to display a first brightness. In some examples, if the supply area door is open the second sensor may send a second signal to the light source to display a second brightness. Accordingly, this disclosure describes systems and methods that allow for illuminated openings of a printing device.

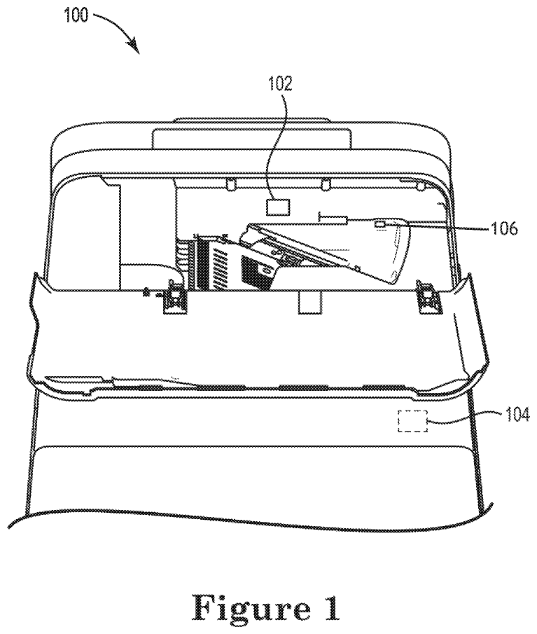

FIG. 1 illustrates an example printing device 100. The printing device 100 may be implemented in a variety of imaging systems, such as inkjet printers or copiers, for example. In some examples, the printing device 100 may include a finishing device coupled to the printing device 100. As used herein, a finishing device includes a device for performing post processing of print media such as stapling, three-hole punching, etc. In some examples, the finishing device may be adjacent to the printing device 100. In some examples, the finishing device may be coupled to a side of the printing device 100. In some examples the finishing device may cause the printing device to include a first door to cover the media pathway.

In some examples, the printing device 100 may include a first sensor 102 to detect when the media pathway is blocked. As used herein, a blocked media pathway refers to print media blocking the media pathway, print media being jammed or lodged in the media pathway, a printing device being unable to remove or eject print media, and/or the printing device being unable to function properly until unwanted print media is removed from the media pathway.

In some examples, the first sensor 102 may send a first signal to the light source 106 when the first sensor 102 detects the media pathway is blocked. In some examples, the first sensor 102 can be a media sensor. As used herein, a media sensor refers to an electronic computing device to detect when the media pathway is blocked, an electronic computing device to send a signal to the light source, and/or an electronic computing device to control the different components of the first enclosure. In some examples, the first signal may cause the light source 106 to display a first brightness. As used herein, a light source refers to an electronic device that generates wavelengths in the visible light spectrum (e.g., 390-700 nanometer wavelength spectrum, etc.). In some examples, the first brightness may be a flashing state. As used herein, a flashing state refers to a light source turning on and off in a repeated fashion. For example, the light source 106 may turn on and off in a repeated fashion until the media pathway is no longer blocked. In some examples, the flashing state of the first brightness may alert a user of a particular issue. For example, if the light source 106 is in a flashing state the user may be alerted that the media pathway is blocked.

In some examples, the printing device 100 may include a second sensor 104. In some examples, the second sensor 104 can be a door sensor. As used herein, a door sensor refers to an electronic computing device to detect when the supply door is in an open or close position, an electronic computing device to detect the amount of print substance supply, an electronic computing device to send a signal to the light source, and/or an electronic computing device to control the different components of the second enclosure. The second sensor 104 may be used to detect when the supply area door is open. In various examples, the second sensor 104 may send a second signal to the light source 106 when the supply area door is open. In some examples, the second signal may cause the light source 106 to display a second brightness. In some examples, the second brightness may be a brightness that is different from the first brightness. However, this disclosure is not so limited. For example, the second brightness may be a brightness that is the same as the first brightness. In some examples, the second brightness may be a constant display of light. For example, the light source 106 may display a continuous light until the supply area door is closed. In some examples, the constant display of light of the second brightness may alert a user that the supply area door is open. In various examples, the constant display of light of the second brightness may alert the user to the location of the print substance supply (e.g., print fluids, print solids, and combinations thereof).

In some examples, the light source 106 may be located above the supply area. For example, the light source 106 may be located above the print substance supply. In some examples, there may be an opening between the first enclosure and the second enclosure that allows the light source 106 to display a light on the supply area.

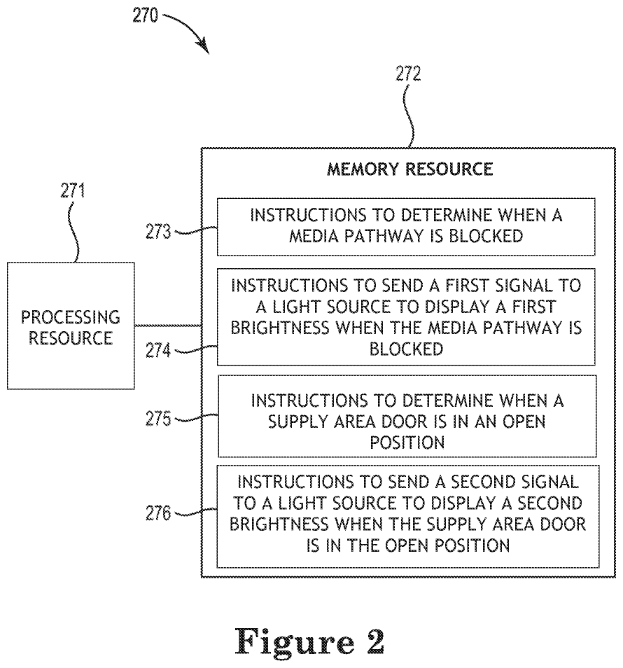

FIG. 2 illustrates an example apparatus 270 for a printing device. As illustrated in FIG. 2, the apparatus 270 includes a processing resource 271 and a memory resource 272. The processing resource 271 may be a hardware processing unit such as a microprocessor, application specific instruction set processor, coprocessor, network processor, or similar hardware circuitry that may cause machine-readable instructions to be executed. In some examples, the processing resource 271 may be a plurality of hardware processing units that may cause machine-readable instructions to be executed. The processing resource 271 may include central processing units (CPUs) among other types of processing units. The memory resource 272 may be any type of volatile or non-volatile memory or storage, such as random access memory (RAM), flash memory, read-only memory (ROM), storage volumes, a hard disk, or a combination thereof.

The memory resource 272 may store instructions thereon, such as instructions 273, 274, 275, and 276. When executed by the processing resource 271, the instructions may cause the apparatus 270 to perform specific tasks and/or functions. For example, the memory resource 272 may store instructions 273 which may be executed by the processing resource 271 to cause the apparatus 270 to determine when a media pathway is blocked. In some examples, if print media is lodge inside the media pathway the printing device may be unable to function. In various examples, if the printing device is processing print media, the processing resource 271 may instruct the first sensor to determine if the media pathway is blocked. In some examples, the first sensor may be an exit sensor that determines if the media pathway is blocked by detecting if print media has exited the printing device. In some examples, the first sensor may be a light sensor that determines if the media pathway is blocked by detecting if print media has crossed a light path.

The memory resource 272 may store instructions 274 which may be executed by the processing resource 271 to cause the apparatus 270 to send a first signal to a light source to display a first brightness when the media pathway is blocked. For example, if the media pathway is blocked, the processing resource 271 may instruct the first sensor to send a first signal to a light source. In some examples, if the first sensor determines that the media pathway is blocked, the processing resource 271 may send a first signal to a light source. In some examples, the light source may display a first brightness when a first signal is received.

The memory resource 272 may store instructions 275 which may be executed by the processing resource 271 to cause the apparatus 270 to determine when a supply area door is in an open position. For example, if a user opens a supply area door or the supply area door is open by other means the second sensor may determine that the supply area door is in an open position. In some examples, the second sensor may be a slot switch sensor that determines if the supply area door is open by detecting a flag inside the sensor.

The memory resource 272 may store instructions 276 which may be executed by the processing resource 271 to cause the apparatus 270 to send a second signal to the light source to display a second brightness when the supply area door is in the open position. For example, if the supply area door is open, the processing resource 271 may instruct the second sensor to send a second signal to the light source. In some examples, if the second sensor determines that the supply area door is open, the processing resource 271 may send a second signal to a light source. In some examples, the light source may display a second brightness.

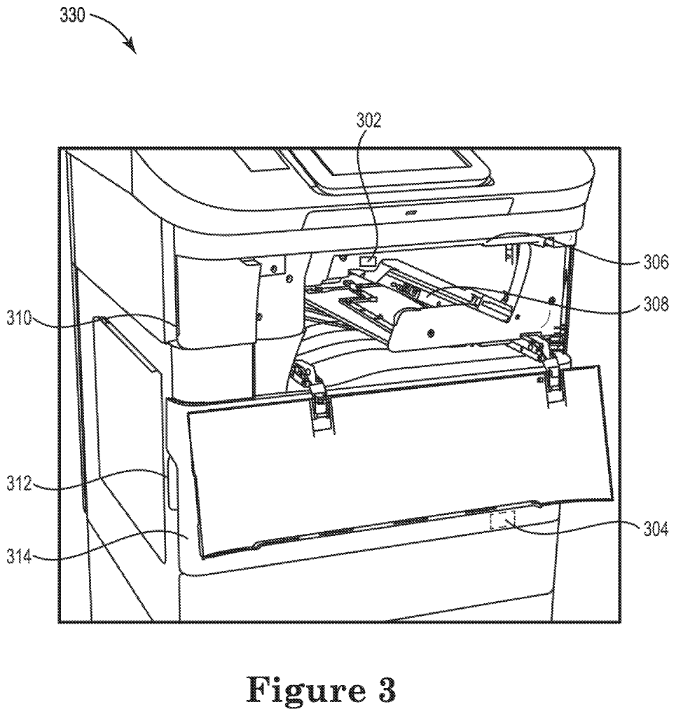

FIG. 3 illustrates an example system 330 for a printing device. In some examples, the system 330 may include a first enclosure 310. In some examples, the first enclosure 310 may include a media pathway 308. In some examples, the media pathway 308 may be located in the center of the first enclosure 310. In some example, the media pathway 308 is the path in which print media is transferred throughout the printing device. In some examples, print media may get lodge in the media pathway 308 as print media is being transferred. For example, print media may block the media pathway 308 while the printing process is occurring. In some examples, the light source 306 may display a first brightness if the media pathway 308 is blocked.

For example, the first enclosure 310 may include a light source 306 to display a first brightness when the media pathway 308 is blocked. In some examples, the light source 306 may be a light emitted diode (LED). However, this disclosure is not so limited. The light source 306 may be a lighting device that is able to display a particular brightness. For example, the light source 306 may be a florescent light source, an incandescent light source, etc. In some examples, the light source 306 may be located adjacent to the media pathway 308 of the first enclosure 310. In some examples, the light source 306 may be located at the distal ends of the first enclosure 310. As used herein, distal end, refers to an end that is within twenty-five percent of a side of the first enclosure. For example, the light source 306 may be located at either end of the media pathway 308. Further, the light source 306 may be located above the media pathway 308, as illustrated in FIG. 3. In some examples, the light source 306 may be located below the media pathway 308. However, this disclosure is not so limited. For example, the light source 306 may be positioned in a location that allows the light source 306 to display a light onto the media pathway 308.

In some examples, the first enclosure 310 may include a first sensor 302 to detect when the media pathway 308 is blocked. As illustrated in FIG. 3, the first sensor 302 may be positioned adjacent to the media pathway 308. In some examples, the first sensor 302 may be positioned on either side of the media pathway 308. In some examples, the first sensor 302 may be positioned at the distal end of the first enclosure 310.

In some examples, when the media pathway 308 is blocked, the first sensor 302 may send a first signal to the light source 306 to display a first brightness. In some examples, the first signal may cause the light source 306 to display a first brightness. For example, the first brightness may display a light in a first direction. As used herein, first direction, refers to a direction that is towards the media pathway. In some examples, the first brightness may be a brightness that is reduced because the media pathway 308 and the light source 306 are both in the first enclosure 310. In some examples, the first brightness may be a flashing state. For example, the light source 306 may turn on and off in a repeated fashion until the media pathway is no longer blocked. In some examples, if the light source 306 is in a flashing state the user may be alerted that the media pathway is blocked. However, this disclosure is not so limited. For example, the first brightness may display light in a state that illuminates the media pathway 308. In some examples, the first brightness may illuminate the media pathway 308 of the first enclosure 310 when the first signal is received by the light source 306.

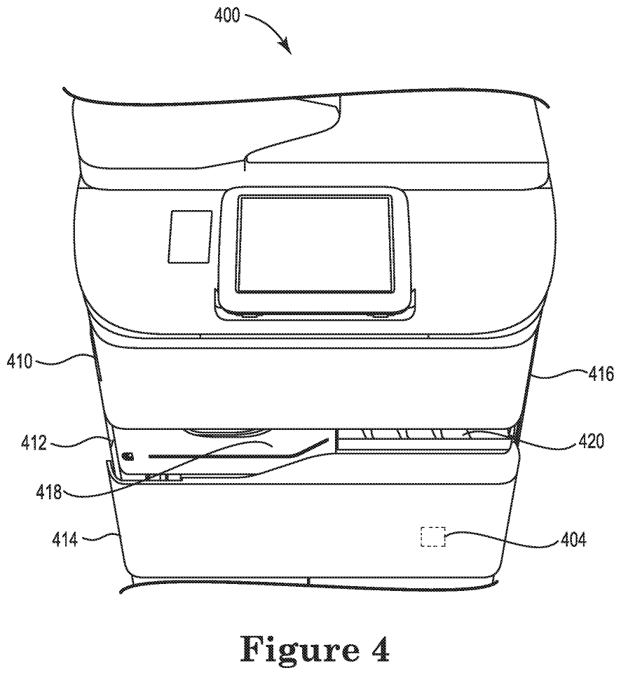

In some examples, the system 330 may include a second enclosure 312. In some examples, the second enclosure 312 may include a supply area (e.g., supply area 418 as illustrated in FIG. 4). As used herein, a supply area refers to an enclosure of the printing device that houses materials to complete a print job, such as, print substance supply, print media, etc. In some examples, the second enclosure 312 may include a second sensor 304 to detect when the supply area door 314 is in an open position.

As illustrated in FIG. 3, the second sensor 304 may be positioned on the inside of the supply area door 314. In some examples, the second sensor 304 may be positioned inside of the second enclosure 312. In some examples, the second sensor 304 may be positioned at the distal end of the second enclosure 312. For examples, the second sensor 304 may be positioned adjacent to the print substance supply of the second enclosure 312.

In some examples, the second sensor 304 may send a second signal to the light source 306 when the supply area door 314 is in an open position. In some examples, the second signal may cause the light source 306 to display a second brightness. For example, the light source 306 may display a second brightness when the supply area door 314 is in an open position. In some examples, the second brightness may illuminate the second enclosure 312 when the second signal is received by a light source 306. In some examples, the light source 306 may be located above the supply area. In some examples, there may be an opening between the first enclosure 310 and the second enclosure 312 that allows the light source 306 to display a light on the supply area.

For example, the second brightness may display a light in a second direction. As used herein, second direction, refers to a direction that is towards the supply area of the second enclosure 312. In some examples, the second brightness may be a brightness that is increased due to the supply area being in the second enclosure 312 and the light source 306 being in the first enclosure 310. In some examples, the second brightness may be a constant display of light. In some examples, the constant display of light of the second brightness may alert a user that the supply area door 314 is open.

In some examples, the first enclosure 310 may be positioned adjacent to the second enclosure 312. For example, the first enclosure 310 may be located on top of the second enclosure 312, as illustrated in FIG. 3. However, this disclosure is not so limited. For example, the first enclosure 310 may be located under (e.g., at the bottom of) the second enclosure 312. In various examples, the first enclosure 310 is connected to the second enclosure 312.

FIG. 4 illustrates an example printing device 400. In some examples, the printing device 400 may include a first enclosure 410. In some examples, the first enclosure 410 may include a media pathway (e.g., media pathway 308 as illustrated in FIG. 3). In some example, the media pathway may be the path in which print media is transferred throughout the printing device 400. In some examples the media pathway may extend throughout the printing device 400. In some examples, print media may lodge in the media pathway as print media is being transferred. In various examples the first enclosure 410 may include a first door 416 to access the media pathway. In some examples, the first door 416 may open within an angle range of from about 25 degrees to about 170 degrees. In some examples, the first enclosure 410 may include a light source (e.g., light source 306 as illustrated in FIG. 3) to display a plurality of brightness.

In some examples, the first enclosure 410 may include a first sensor (e.g., first sensor 302 as illustrated in FIG. 3) to detect when the media pathway is blocked. In some examples, the first sensor may be positioned at the distal end of the first enclosure 410. In some examples, when the media pathway is blocked the first sensor may send a first signal to the light source to display a first brightness. In some examples, the first signal may cause the light source to display a first brightness. For example, the first brightness may display a light in a first direction. In some examples, the first brightness may be a flashing state. For example, the light source may turn on and off in a repeated fashion until the media pathway is no longer blocked. In some examples, the first brightness may illuminate the media pathway of the first enclosure 410 when the first signal is received by a light source. For example, the light source may display a flashing light on the media pathway to alert a user that the media pathway is blocked.

In some examples, the printing device 400 may include a second enclosure 412. In some examples, the second enclosure 412 may include a second sensor 404 to detect when the supply area door 414 is in an open position. In some examples, the second sensor 404 may be positioned on the inside of the supply area door 414. In some examples, the second sensor 404 may be positioned inside of the second enclosure 412.

In some examples, the second sensor 404 may send a second signal to the light source when the supply area door 414 is in an open position. In some examples, the second signal may cause the light source to display a second brightness. For example, the second brightness may display a light in a second direction. In some examples, the light source may display a second brightness when the supply area door 414 is in an open position. In some examples, the second brightness may be a constant display of light. For example, the light source may display a continuous light until the supply area door 414 is closed. In some examples, the constant display of light may alert the user of the location of the print substance supply 420. In some examples, the constant display of light of the second brightness may alert a user that the supply area door 414 is open. In some examples, the supply area door 414 may open by being pulled away from the printing device 400. However, this disclosure is not so limited. For example, the supply area door 414 may open in a way that allows access to the supply area 418.

In some examples, the second enclosure 412 may include a supply area 418. In some examples, the supply area 418 may house a print substance supply 420. In some examples, the second brightness may illuminate the print substance supply 420 housed in the second enclosure 412, when the second signal is sent. In some examples, the second brightness may illuminate the entire supply area 418 when the second signal is sent. For example, the light source may be located above the supply area 418. In various examples, the light source may be located above the print substance supply 420. In some examples, there may be an opening between the first enclosure 410 and the second enclosure 412 that allows the light source to display a light to the supply area 418.

In some examples, the second sensor 404 may send a third signal to the light source when the print substance supply 420 is low. In some examples, the second sensor 404 may send a third signal to the light source when the print substance supply 420 is low and the supply area door 414 is open. In some examples, the third signal may cause the light source to display a third brightness. In some examples, the light source may display a third brightness on the print substance supply 420 when the print substance supply 420 is low. In some examples, the third brightness may illuminate the second enclosure 412 when the third signal is sent. For example, the third brightness may display a light in the second direction. In some examples, the third brightness may be a brightness that is increased because the print substance supply 420 is in the second enclosure 412 and the light source is in the first enclosure 410. In some examples, the third brightness may be a brightness that is different from the first and second brightness. However, this disclosure is not so limited. For example, the third brightness may be a brightness that is the same as the first and second brightness.

In some examples, the first enclosure 410 may be located on top (e.g., a position that comes before, etc.) of the second enclosure 412, as illustrated in FIG. 4. In various examples, the first enclosure 410 may be adjacent to the second enclosure 412.

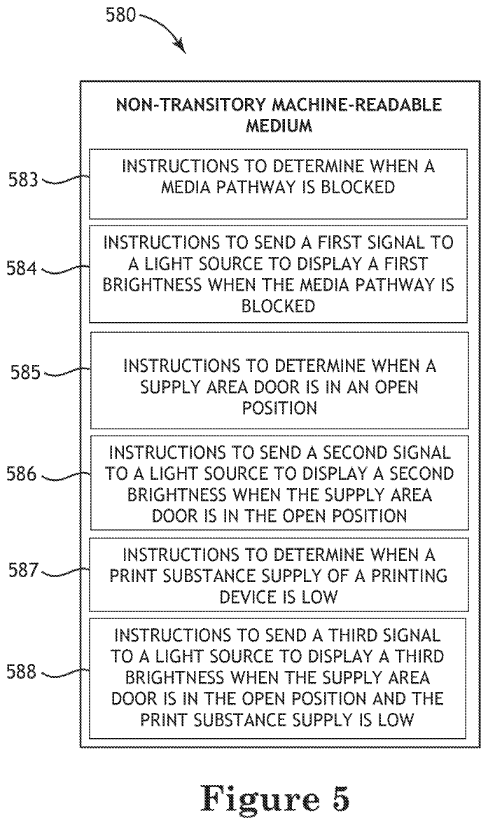

FIG. 5 illustrates an example diagram of a medium 580 for a printing device. A processing resource may execute instructions stored on the non-transitory machine readable medium 580. The non-transitory machine readable medium 580 may be any type of volatile or non-volatile memory or storage, such as random access memory (RAM), flash memory, read-only memory (ROM), storage volumes, a hard disk, or a combination thereof.

The medium 580 stores instructions 583 executable by a processing resource to determine when a media pathway is blocked. In some examples, if print media is lodge inside the media pathway the printing device may be unable to function. In various examples, if the printing device is processing print media, the medium 580 may instruct the first sensor to determine if the media pathway is blocked. In some examples, the first sensor may be an exit sensor, that determines if the media pathway is blocked by detecting if print media has exited the printing device. In some examples, the first sensor may be a light sensor that determines if the media pathway is blocked by detecting if print media has crossed a light path.

The medium 580 stores instructions 584 executable by a processing resource to send a first signal to a light source to display a first brightness when the media pathway is blocked. For example, if the media pathway is blocked, the medium 580 may instruct the first sensor to send a first signal to a light source. In some examples, if the first sensor determines that the media pathway is blocked, the medium 580 may send a first signal to a light source. In some examples, the light source may display a first brightness when a first signal is received.

The medium 580 stores instructions 585 executable by a processing resource to determine when a supply area door is in an open position. For example, if the supply area door is opened the second sensor may determine that the supply area door is in an open position. In some examples, the second sensor may be a slot switch sensor that determines if the supply area door is open by detecting a flag inside the sensor.

The medium 580 stores instructions 586 executable by a processing resource to send a second signal to the light source to display a second brightness when the supply area door is in the open position. For example, if the supply area door is open, the medium 580 may instruct the second sensor to send a second signal to the light source. In some examples, if the second sensor determines that the supply area door is open, the medium 580 may send a second signal to a light source. In some examples, the light source may display a second brightness.

The medium 580 stores instructions 587 executable by a processing resource to determine when the print substance supply of a printing device is low. For example, if the print substance supply reaches a threshold level the second sensor may determine that the print substance supply is low.

The medium 580 stores instructions 588 executable by a processing resource to send third signal to the light source to display a third brightness when the supply area door is in the open position and the print substance supply is low. For example, the second sensor may send a third signal to the light source when the second sensor determines that the print substance supply is low. In some examples, the light source may display a third brightness when the third signal is sent by the second sensor. For example, if the print substance supply is low, the medium 580 may instruct the second sensor to send a third signal to the light source. In some examples, if the second sensor determines that the print substance supply is low, the medium 580 may send a third signal to a light source. In some examples, the light source may display a third brightness when the third signal is received.

The figures herein follow a numbering convention in which the first digit corresponds to the drawing figure number and the remaining digits identify an element or component in the drawing. Elements shown in the various figures herein may be capable of being added, exchanged, and/or eliminated so as to provide a number of additional examples of the disclosure. In addition, the proportion and the relative scale of the elements provided in the figures are intended to illustrate the examples of the disclosure, and should not be taken in a limiting sense.

It should be understood that when an element is referred to as being “on,” “in contact,” “connected to”, “coupled to”, or “coupled with” another element, it may be directly on, in contact, connected, or coupled with the other element or intervening elements may be present. In contrast, when an object is “directly coupled to” or “directly coupled with” another element it is understood that are no intervening elements (adhesives, screws, other elements) etc.

It should be understood that when an element is referred to as being “adjacent” to another element, it may be on, in contact, connected, next to, or coupled with the other element.

It should be understood that the descriptions of various examples may not be drawn to scale and thus, the descriptions may have a different size and/or configuration other than as shown therein.

While some elements are designated as a “top” or a “bottom” and/or “front” or “back,” it should be understood that such elements may correspond to other relative terms or possible orientations in some applications in order to practice the examples of this disclosure.

What is claimed:

1. A printing device comprising:
a first sensor to detect when a media pathway is blocked and to send a first signal to a light source to display a first brightness; and
a second sensor to detect when a supply area door is in an open position and to send a second signal to the light source to display a second brightness.

2. The printing device of claim 1, comprising a supply area coupled to the supply area door, wherein a print substance supply is housed in the supply area.

3. The printing device of claim 2, wherein the light source is to illuminate the print substance supply housed in the supply area by displaying the second brightness.

4. The printing device of claim 3, wherein the light source is to illuminate the print substance supply housed in the supply area when the supply area door is in the open position.

5. The printing device of claim 1, wherein the light source is a light emitted diode (LED).

6. The printing device of claim 1, wherein the first brightness is different than the second brightness.

7. A non-transitory machine-readable medium storing instructions that, when executed by a processing resource, cause the processing resource to:
determine when a media pathway is blocked;
send a first signal to a light source to display a first brightness when the media pathway is blocked;
determine when a supply area door is in an open position; and
send a second signal to the light source to display a second brightness when the supply area door is in the open position.

8. The medium of claim 7, wherein the first brightness includes a flashing state.

9. The medium of claim 7, storing instruction to:
determine when a print substance supply of a printing device is low; and
send a third signal to the light source to display a third brightness when the supply area door is in the open position and the print substance supply is low.

10. A system for a printing device comprising:
a first enclosure including:
a light source;
a media pathway;
a first sensor to detect when the media pathway is blocked and send a first signal to the light source to display a first brightness; and
a second enclosure including:
a supply area door; and
a second sensor to detect when the supply area door is in an open position and send a second signal to the light source to display a second brightness.

11. The system of claim 10, wherein the media pathway is housed in the first enclosure of the printing device.

12. The system of claim 10, wherein the light source is to illuminate the media pathway when the first brightness is displayed.

13. The system of claim 10, wherein the light source is to illuminate the second enclosure of the printing device when the second brightness is displayed.

14. The system of claim 10, wherein the first enclosure includes a first door to access the media pathway.

15. The system of claim 14, wherein the first door is to open within an angle range of from about 25 degrees to about 170 degrees.
